(19) United States
(12) Patent Application Publication
(10) Pub. No.: US 2008/0072733 A1
(43) Pub. Date: Mar. 27, 2008

(54) Saw Chain for A Power Chain Saw

(76) Inventors: Matthias Schulz, Freiberg (DE); Berthold Schell, Backnang (DE); Marco Kewes, Konstanz (DE); Gunther Stoll, Waiblingen (DE); Jorg Braunche, Jonschwil (CH); Michael Bruck, Bazenheid (CH); Rainer Ruhle, Will (CH)

Correspondence Address: ROBERT W. BECKER & ASSOCIATES, 707 HIGHWAY 333, SUITE B, TIJERAS, NM, 87059-7507, US

(21) Appl. No.: 11/872,396

(22) Filed: Oct. 15, 2007

Related U.S. Application Data
(63) Continuation-in-part of application No. 11/000,765, filed on Dec. 1, 2004, now abandoned.

(51) Int. Cl. B27B 33/14

(52) U.S. Cl. 83/834

(57) ABSTRACT

A saw chain for the guide bar of a power chain saw includes pivotably interconnected drive links, cutting links or connecting links. The cutting link has a cutting tooth and a depth limiter that leads the cutting tooth. The drive link adjacent to the depth limiter is provided with a support protuberance and a support surface that during travel of the saw chain about the end of the guide bar cooperates in a supporting manner with the depth limiter. With the saw chain extended, the support protuberance has a smaller spacing to the cutting tooth than does the depth limiter. During travel of the saw chain about the end of the guide bar, the spacing of the support protuberance to the cutting tooth increases to a reversal spacing that is greater than the spacing of the depth limiter to the cutting tooth. In a side view of the saw chain, the spacing between the cutting tooth and the depth limiter is limited by the support protuberance. The support surface in both the extended state and during travel about the end of the guide bar lies beneath the top surface of the depth limiter.

### CROSS REFERENCE

The present application is a continuation-in-part application of co-pending U.S. application Ser. No. 11/000,765.

### BACKGROUND OF THE INVENTION

The present invention relates to a saw chain for the guide bar of a power chain saw, comprising pivotably interconnected chain links, including drive links, cutting links, and connecting links, wherein each drive link is pivotably connected with several lateral connecting links and a lateral cutting link such that in the longitudinal direction of the chain, successive cutting links are alternatingly disposed on the right and the left longitudinal sides of the chain, and the cutting link is provided with a cutting tooth and a depth limiter that leads the cutting tooth in the direction of travel of the chain, whereby the drive link that is adjacent to the depth limiter is provided with a support protuberance that in the longitudinal direction of the chain extends in the region of the depth limiter of the cutting link, and a support surface of the support protuberance, at least when the saw chain travels about the end of the guide bar, cooperates in a supporting manner with the top surface of the depth limiter in the groove cut into a work piece.

A saw chain of this type is known from U.S. Pat. No. 3,180,378. Each second drive link has a support protuberance that extends rearwardly in the direction of travel of the chain approximately from the center of the drive link, and in this manner extends the depth limiter of the cutting link toward the front in the direction of travel of the chain. As a result, the kick-back tendency of the power chain saw can be lowered, especially during contact with the end of the bar.

GB 2 109 455 A discloses a chain saw where each second cutting link carries a support protuberance, that, when the saw chain is extended, ends below the top surface of the depth limiter of the cutting link. During travel or reversal about the end of the guide bar, the support protuberance pivots toward the front in the direction of travel of the chain and increases the effective support surface, as a result of which the kick-back tendency is lower during contact with the bar end.

It is an object of the invention to provide a saw chain for a power chain saw that has an only low kick-back tendency at a high cutting power.

### SUMMARY OF THE INVENTION

The spacing of the support protuberance to the cutting tooth, measured in the longitudinal direction of the chain, when the saw chain is straight or extended, is less than the spacing of the depth limiter to the cutting tooth, so that when the chain is extended, the support protuberance is effective in the region between the depth limiter and the cutting tooth and ensures a reliable support.

During the travel or reversal over the end of the guide bar, due to the kinematics the spacing of the support protuberance to the cutting tooth changes to a reversal spacing that is greater than the spacing of the depth limiter to the cutting tooth. During the reversal at the end of the guide bar, the support protuberance is thus pivoted forwardly out of the region of the depth limiter in the direction of travel of the chain, as a result of which on the one hand the support surface is enlarged in the longitudinal direction of the chain, and on the other hand an effective support also results transverse to the direction of travel of the chain.

Therefore, the support surface lies beneath the top surface of the depth limiter both when the saw chain is in the extended state and during travel about the end of the guide bar. In this manner, the cutting depth is limited by the depth limiter during normal operation of the saw chain. The support surface of the support protuberance serves only for lateral guidance. The support protuberance that defines the space between the cutting tooth and the depth limiter likewise contributes to limiting the cutting depth only at a high feed rate of the saw chain in the extended state of the saw chain. In this manner, also with a high feed rate, a sufficient limiting of the cutting depth can be guaranteed. At the same time, the cutting depth is always limited by the depth limiter in the area of travel about the end of the guide bar.

Pursuant to an advantageous further development of the invention, the support protuberance essentially extends in a portion of the drive link that is connected via a rivet pin with the portion of the cutting link that is provided with the depth limiter.

The drive link has an approximately perpendicular central plane that is disposed parallel to the center axes of the rivet openings and is provided centrally between the center axes. This central plane divides the drive link into a leading and a trailing half, whereby the support protuberance is disposed in the trailing half over its entire length that is effective in the longitudinal direction of the chain. As a result, the effectiveness of the support protuberance is increased during the travel about the end of the guide bar.

Pursuant to a particular structural embodiment, the end face of the support protuberance that faces the cutting tooth is oriented essentially parallel to the central plane of the drive link, whereby as a supplement thereto, the support surface of the support protuberance is disposed at a right angle to the central plane of the drive link, and hence at a right angle to the end face. By means of a transition of combined, changing radii, the support surface merges into an upper main body plane of the central or drive link. The particular structural configuration of the contour of the drive link ensures an advantageous manufacture as well as assembly to form the chain composite.

Advantageously, the drive link has an approximately perpendicular central plane, which divides the drive link into a leading half and a trailing half, whereby the drive link has only one support protuberance, which is disposed in the trailing half of the drive link. The support surface of the support protuberance passes over a transition made up of varying radii into an upper main body plane of the drive link. One radius is formed concavely, whereby the center point of the concave radius lies above the support surface. By locating the center point of the radius above the support surface, a much larger radius is provided, which leads to an easy, gradual transition from the support surface into the upper main body plane. The varying radii cause at the same time a more gradual transition than a structure of the transition with the even or linear sections.

Further specific features of the present application will be described in detail subsequently.

### BRIEF DESCRIPTION OF THE DRAWINGS

The objects and advantages of the present invention will appear more clearly from the following specification in conjunction with the accompanying schematic drawings, in which:

FIG. 1 shows an isometric partial view of one exemplary embodiment of a saw chain that is traveling on a guide bar;

FIG. 2 shows an isometric view of an extended portion of the saw chain of FIG. 1;

FIG. 3 is a side view of the saw chain of FIG. 2;

FIG. 4 is a side view of a drive link of the saw chain;

FIG. 5 is an isometric view of the drive link of FIG. 4; and

FIG. 6 is a side view of one embodiment of a saw chain.

### DESCRIPTION OF SPECIFIC EMBODIMENTS

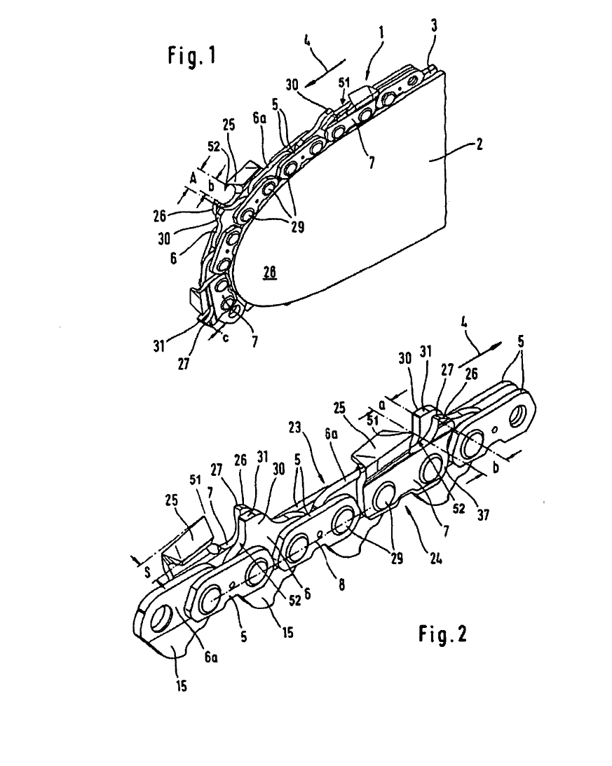

The saw chain 1 illustrated in FIG. 1 runs on a guide bar 2, which is secured to a non-illustrated power chain saw. For the guidance of the saw chain 1, a guide groove or channel 3 is provided in the outer periphery of the guide bar 2. Drive links 6 of the saw chain 1 are centrally guided in the guide channel 3 in the direction of travel 4 of the chain.

The saw chain 1 comprises individual, pivotably interconnected chain links, which are embodied as lateral connecting links 5, central drive links 6, 6a, and lateral cutting links 7.

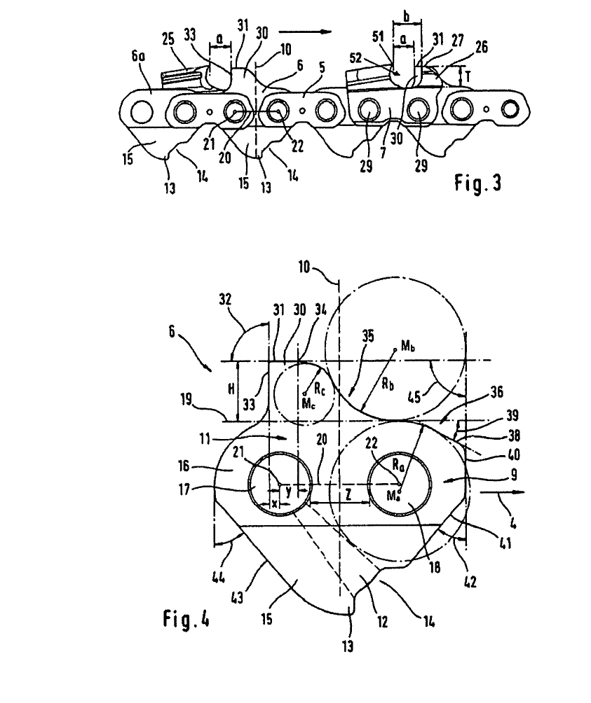

As shown in FIGS. 2 to 5, the drive link 6 comprises a main body 16 that, in the longitudinal direction 8 of the chain (FIG. 2), is provided with two rivet openings 17 and 18 that are spaced apart by a distance z. The main body 16 has an upper main body plane 19 that is disposed approximately parallel to a connecting plane 20 (FIGS. 3, 5) that is determined by the center axes 21 and 22. Formed on that side of the main body 16 that is opposite the main body plane 19 is a drive extension 15 that extends into the guide channel 3 of the guide bar 2. Facing toward the front in a direction of travel 4 of the chain, the drive extension 15 has a lubricant opening 14 into which a drive nose 13 conveys lubricant that the drive nose 13 receives from the base of the guide channel 3 of the guide bar 2. In a manner not illustrated in greater detail, the lubricant that is received is conveyed to the rivet opening 17 via a lubricant channel 12 that is formed in the side surface of the drive link 6.

Each drive link 6 is pivotably connected via rivet pins 29 with several lateral connecting links 5 and a cutting link 7 (FIGS. 2, 3).

The drive link 6 has an approximately perpendicular central plane 10 that extends parallel to the center axes 21 and 22 of the pivot openings 17 and 18. The central plane 10 furthermore symmetrically divides the connecting plane 20 that is defined between the center axes 21 and 22.

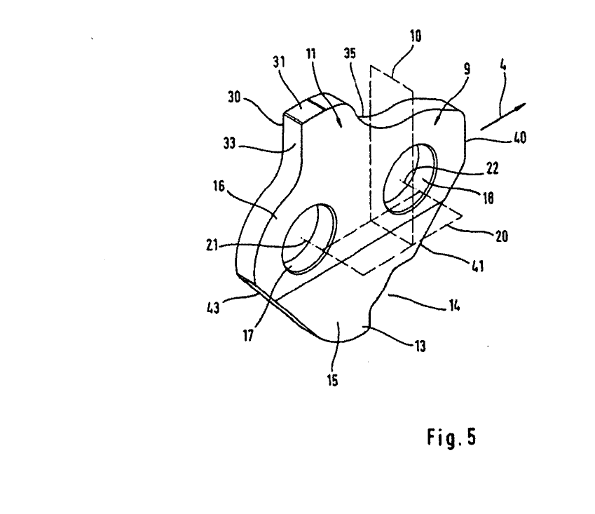

By means of the central plane 10, which is perpendicular to the main body plane 19, the drive link is divided into a leading half 9 and a trailing half 11. The half 11, which trails in the direction of travel of the chain, is provided with a support projection or protuberance 30 that extends beyond the main body plane 19 by a prescribed height H. The leading half 9 of the drive link 6 does not have a support protuberance. The drive link having the support protuberance 30, and shown in FIGS. 4 and 5, is arranged in the composite chain connection in such a way that the leading half 9 of the drive link 6 is connected with two connecting links 5 (FIGS. 2, 3), while the trailing half 11 on the one longitudinal side 24 of the chain is connected with a connecting link 5 and on the other longitudinal side of the chain is connected with a cutting link 7. In this connection, the support protuberance 30 is arranged in such a way that it is disposed in the region of a depth limiter 26 that is provided on the cutting link 7 and leads a cutting tooth 25. Disposed between two drive links 6 having a support protuberance 30 is a drive link 6a having a planar main body plane 19, so that in the longitudinal direction 8 of the chain, drive links 6 having support protuberances 30 alternate with drive links 6a having no support protuberance. In this connection, the position of the cutting links 7 relative to the longitudinal sides 23 and 24 of the chain are provided in such a way that in the longitudinal direction 8 of the chain, successive cutting links 7 are alternatingly disposed on the right and the left longitudinal sides 23, 24. The cutting links 7 disposed on a given longitudinal side 23 or 24 of the chain are respectively separated from one another, in the longitudinal direction 8 of the chain, by three connecting links 5.

The support protuberance 30 of a central drive link 6 extends, in the longitudinal direction 8 of the chain, in the region of the depth limiter 26 of the cutting link 7, whereby a support surface 31 of the support protuberance 30—and also the top surface 27 of the depth limiter 26—face the base of a cutting groove in a work piece. In this connection, the support surface 31 and the top surface 27 cooperate in a supporting manner, at least in the reversal region of the tip or end of the guide bar 2, to lower a kick-back action. As shown in FIG. 1, in the reversal region of the end 28 of the guide bar 2, the top surface 27 and the support surface 31 are disposed at approximately the same height, or the support surface 31 is preferably disposed below the top surface 27, so that in the vertical direction of the saw chain 1 perpendicular to the direction of travel 4, a spacing c is formed between the support surface 31 and the top surface 27.

The support protuberance 30 essentially extends in a portion 11 of the drive link 6 that is connected via a rivet pin 29 with the portion 37 of the cutting link 7 that is provided with the depth limiter 26 (FIG. 2). The dimension of the support protuberance 30 measured in the longitudinal direction 8 of the chain is such that when the saw chain 1 is straight or extended, the spacing a of the support protuberance 30 to the cutting tooth 25, measured in the longitudinal direction 8 of the chain, is less than the spacing b that the depth limiter 26 has to the cutting tooth 25. The spacings a and b therefore are measured in a side view of the saw chain 1, whereby the lateral offset between the support protuberance 30 and the cutting tooth 25 is not taken into consideration. The spacing a as well as the spacing b are measured relative to the traveling end 51 of the cutting tooth 25. The kinematic dimensions are selected such that as the saw chain 1 travels around the end 28 of the guide bar 2, the spacing a of the support protuberance 30 to the cutting tooth 25 increases in such a way to a reversal spacing A that as the saw chain 1 travels around the end 28 of the guide bar 2, the reversal spacing A is greater than the spacing b of the depth limiter 26 to the cutting tooth 25. In so doing, when the saw chain 1 is extended, the space between the cutting tooth 25 and the leading depth limiter 26 is partially delimited by the support protuberance 30. When the saw chain 1 is extended, the support surface 31 is disposed approximately at the level of the top surface 27 of the depth limiter 26, or slightly below the top surface 27 of the depth limiter 26, as can be seen from the side view in FIG. 3.

During the travel or reversal about the end 28 of the guide bar 2, due to the kinematics, a relative movement occurs between the depth limiter 26 and the support protuberance, as a result of which the support protuberance 30 and the support surface 31 are pivoted out of the space 52 between the depth limiter 26 and the cutting tooth 25. At the same time, during the travel about the end 28 of the guide bar 2, the support surface 31 drops relative to the top surface 27, so that in the region of the end 28 the support surface 21 comes to rest below the top surface 27 or approximately at the same height as the top surface 27. A support of the saw chain 1 in the cutting base is effective over a width that essentially corresponds to the width S (FIG. 2) of the cutting tooth 25. As a consequence of this large support surface, which extends not only transverse to the longitudinal direction 8 of the chain but also in the longitudinal direction 8 of the chain, the kick-back tendency during contact with the bar end 28 can be kept low.

In the illustrated embodiment, the support protuberance 30 has such a height H that it corresponds approximately to the height T (FIG. 3) of the depth limiter 26 of the cutting link 7. The support surface 31 and the top surface 27 are then disposed at the same height. Advantageously, the height H is less than the height T, so that the support surface 31 of the support protuberance 30 lies below the top surface 27 of the depth limiter 26. In this connection, the support protuberance 30 has an end face 33 that faces the cutting tooth 25 and that is disposed essentially parallel to the central plane 10 of the drive link 6. The support surface 31 of the support protuberance 30 is preferably disposed at a right angle 32 to the end face 33, and hence also at an approximately right angle to the central plane 10 of the drive link 6.

The support surface 31 of the support protuberance 30 extends over a length, in the longitudinal direction 8 of the chain, that—when viewed in plan—extends from a region after the center axis 21 of the trailing rivet opening 17 up to into a region ahead of the center axis 21 of the rivet opening 17. In the illustrated exemplary embodiment, the end face 33 is disposed by a distance x after the center axis 21 in the longitudinal direction 8 of the chain, i.e., the center axis 21 leads the end face 33 in the direction of travel 4 of the chain by the distance x. The leading edge 34 of the support surface 31 is disposed—as viewed in plan upon the support surface 31—by a distance y to the center axis 21 of the trailing rivet opening 17, i.e., the leading edge 31 is disposed ahead of the center axis 21 of the trailing rivet opening 17 in the direction of travel 4 of the chain by a distance y.

The support surface 31 merges into the main body plane 19 via a transition 35 of changing radii R_{c}, Rb In this connection, first adjoining the edge 34 is a convex, smaller radius R_{c}, which then extends in a concave, many times greater radius R_{b} that merges tangentially into the main body plane 19. The center point M_{c} of the smaller radius R_{c} is disposed advantageously above the main body plane 19 in the support protuberance 30. The center point Mb of the larger radius R_{b} is disposed above the main body plane 19 and above the support surface 31. By positioning the center point Mb above the support surface 31, a larger radius R_{b} is provided, which causes a slightly rounded, gradual transition of the support protuberance into the main body plane 19. The structure of the transition 35 leads to minimal operating noise of the saw chain 1 and prevents the accumulation of dirt on the support protuberance 30. The transition 35 preferably continues in a portion 36 that is disposed below the main body plane 19 and begins approximately on a level with the center axis 22 of the leading rivet opening 18. The center point Ma of the convex radius Rₐ lies below the main body plane 19 within the leading rivet opening 18 in a minimal spacing relative to the central axis 22 beneath the central axis 22. The ending portion 36 is convexly rounded with a radius Rₐ whereby the radius Rₐ is preferably less than the radius R_{b}. The radius Rₐ merges into a tangent 38 that is disposed at an angle 39 of approximately 10° to 50°, in particular approximately 30°, to the main body plane 19. The tangent 38 merges via a small radius into a front end face 40 that is disposed parallel to the central plane 10, that faces toward the front in the direction of travel 4 of the chain, and that is disposed at a right angle 45 to the working or support surface 31. Adjoining the leading end face 40 is the boundary edge 41 of the drive extension 15. The boundary edge 41 is disposed at an angle 42 of about 50° to the central plane 10.

The trailing boundary edge 43 is disposed at an angle 34 to the central plane 10, whereby the angles 42 and 44 are preferably the same.

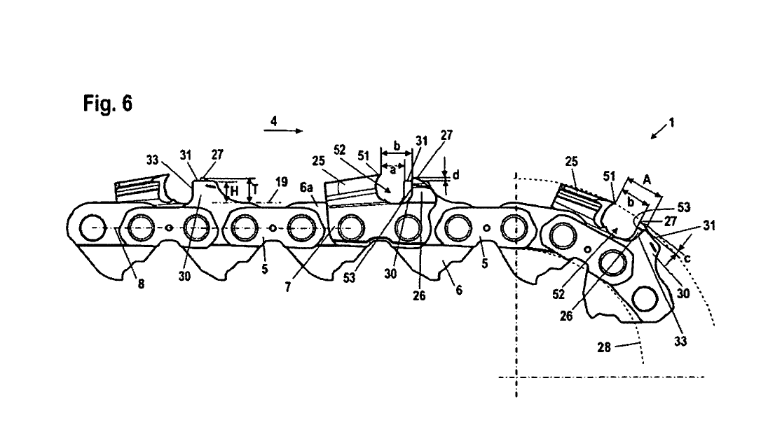

FIG. 6 shows an embodiment of a saw chain 1, whose structure essentially corresponds to the saw chain shown in FIGS. 1 through 5. The same reference numerals in both figures designate corresponding elements. With the saw chain 1 shown in FIG. 6, the space 52 between the depth limiter 26 and the cutting tooth 25 is partially limited by a support protuberance 30, which is arranged on a drive link 6 leading relative to the cutting tooth 25 with reference to the traveling direction 4 of the saw chain 1. In a side view of the saw chain 1, the support protuberance 30 has a spacing a to the cutting tooth 25, and indeed to the leading end 51 of the cutting tooth 25. The support protuberance 30 is disposed laterally offset to the end 51. This lateral offsetting is still not taken into consideration with the spacing a measured in the longitudinal direction of the chain. The depth limiter 26 has a spacing b to the end 51 of the cutting tooth 25, which is greater than the spacing a. In this manner, when viewed from the side of the saw chain 1, the support protuberance 30 projects into the space 52 between the depth limiter 26 and the cutting tooth 25. As FIG. 6 shows, the support surface 31 of the support protuberance 30 is disposed below the top surface 27 of the depth limiter 26. The support surface 31 has a spacing d to the top surface 27. The height H of the support protuberance 30, which is measured starting from the main body plane 19 perpendicular to the direction of travel 4 of the chain, is smaller than the height T of the depth limiter 26. The height T likewise is measured relative to the main body plane 19.

During travel about the end 28 of the guide bar 2, shown in dashed lines in FIG. 6, the support protuberance 30 pivots from the space 52. The front face 33 of the support protuberance lies on the vertical side of the depth limiter 26 facing the cutting tooth 25. As shown in FIG. 6, the spacing between the support protuberance 30 and the end 51 of the cutting tooth 25 expands to a spacing A, which is greater than the spacing b between the depth limiter 26 and the cutting tooth 25. The spacings a, A, and b therefore are measured respectively between the end 51 of the cutting tooth 25 and the front faces 33 and 53 of the support protuberance 30 and depth limiter 26 in the longitudinal direction of the chain.

As shown in FIG. 6, the support surface 31 of the support protuberance 30 also lies beneath the top surface 27 of the depth limiter 26 during travel about the end 28 of the guide bar 2. The support surface 31 has a spacing c to the top surface 27 during travel about the end 28 of the guide bar 2. In this manner, the cutting depth during normal operation in the area of the end 28 of the guide bar 2 as well as in the area of the sides of the guide bar 2 is determined by the depth limiter 26. The cutting depth in the lateral area of the guide bar 2, on which the saw chain 1 extending on the guide bar 2 is arranged, can be determined additionally by the support protuberance 30 only at a greater feed rate, whose support surface 31 can come into contact with the base of the groove based on the higher feed rate.

The specification incorporates by reference the disclosure of German priority document 103 56 636.8 filed Dec. 1, 2003.

The present invention is, of course, in no way restricted to the specific disclosure of the specification and drawings, but also encompasses any modifications within the scope of the appended claims.

What we claim is:

1. A saw chain for a guide bar of a power chain saw, comprising:
pivotably interconnected chain links, including drive links, cutting links, and connecting links, wherein each of said drive links is pivotably connected with several lateral connecting links, and a lateral cutting link, such that successive ones of said cutting links, in a longitudinal direction of said saw chain, are alternatingly disposed on a right and a left longitudinal side of said saw chain, wherein said cutting link is provided with a cutting tooth and a depth limiter that leads said cutting tooth in a direction of travel of said saw chain, wherein a drive link that is adjacent to said depth limiter is provided with a support protuberance that in said longitudinal direction of said saw chain extends in a region of said depth limiter of said cutting link, wherein said support protuberance has a support surface that, at least when said saw chain travels about an end of said guide bar, is adapted to cooperate in a supporting manner with a top surface of said depth limiter in a groove cut into a work piece, wherein in an extended state of said saw chain a spacing of said support protuberance to said cutting tooth, as measured in said longitudinal direction of said saw chain, is less than a spacing of said depth limiter to said cutting tooth, wherein in the extended state of said saw chain, in a side view of the saw chain, the spacing between the cutting tooth and the depth limiter is limited by the support protuberance, wherein when said saw chain travels about said end of said guide bar, said spacing of said support protuberance to said cutting tooth increases to a reversal spacing that is greater than said spacing of said depth limiter to said cutting tooth, and wherein when said saw chain travels about said end of said guide bar, the support protuberance is pivoted out from the space between the cutting tooth and the depth limiter in a side view of the saw chain, wherein the support surface in both the extended state and during travel about said end of said guide bar lies beneath the top surface of the depth limiter.

2. A saw chain according to claim 1, wherein said support protuberance essentially extends in a portion of said drive link that is connected via a rivet pin with a portion of said cutting link that is provided with said depth limiter.

3. A saw chain according to claim 1, wherein said drive link is provided with an approximately perpendicular central plane that is disposed parallel to, and centrally between, center axes of rivet openings of said drive link, wherein said central plane divides said drive link into a leading half and a trailing half, and wherein said support protuberance is disposed in said trailing half.

4. A saw chain according to claim 3, wherein said support protuberance is provided with an end face that faces said cutting tooth and is disposed essentially parallel to said central plane of said drive link.

5. A saw chain according to claim 3, wherein said support surface of said support protuberance is disposed at an approximately right angle to said central plane of said drive link.

6. A saw chain according to claim 5, wherein said support surface merges into an upper main body plane of said drive link via a transition that is composed of changing radii.

7. A saw chain according to claim 6, wherein said transition extends via a further radius into a tangent that is disposed at an angle of approximately 10° to 50° to said main body plane.

8. A saw chain according to claim 7, wherein said angle is approximately 30°.

9. A saw chain according to claim 3, wherein said drive link has a main body, and wherein said main body is provided with a leading end face that is disposed approximately parallel to said central plane of said drive link.

10. A saw chain according to claim 3, wherein said drive link is provided with a drive extension, wherein said drive extension is provided with boundary edges that are disposed below a connecting plane of said center axes of said rivet opening, and wherein said boundary edges are disposed at the same angle to said central plane of said drive link.

11. A saw chain according to claim 10, wherein said angle is approximately 50°.

12. A saw chain according to claim 1, wherein each second drive link is provided with said support protuberance over a length of said saw chain.

13. A saw chain according to claim 1, wherein said support surface of said support protuberance is disposed lower than said top surface of said depth limiter during travel of said chain about said end of said guide bar.

14. A saw chain according to claim 1, wherein the drive link has an approximately perpendicular central plane, wherein said central plane lies parallel to, and centrally between, center axes of rivet openings of said drive link, wherein said central plane divides said drive link into a leading half and a trailing half, and wherein said support protuberance is disposed in said trailing half, so that in the leading half, no support protuberance is provided, wherein the support surface of the support protuberance passes over a transition composed of varying radii into an upper main body plane of the drive link, wherein one radius is concavely formed, and wherein a center point of the concave radius lies above the support surface.
